(19) United States
(12) Patent Application Publication
(10) Pub. No.: US 2025/0037587 A1
(43) Pub. Date: Jan. 30, 2025

(54) Aircraft piloting assistance method, and associated electronic piloting assistance device and assistance system

(71) Applicant: THALES, Meudon (FR)

(72) Inventors: Jaime DIAZ-PINEDA, MERIGNAC (FR); Thomas DE LARD, MERIGNAC (FR); Baptiste IDIART, MERIGNAC (FR)

(21) Appl. No.: 18/716,453

(22) PCT Filed: Dec. 15, 2022
(86) PCT No.: PCT/EP2022/086202

§ 371 Date: Jun. 4, 2024

(30) Foreign Application Priority Data
Dec. 17, 2021 (FR) FR2113848

(51) Int. Cl. G08G 5/00; G06N 3/092

(52) U.S. Cl. CPC G08G 5/0021; G06N 3/092

(57) ABSTRACT

A method for assisting the piloting of an aircraft, including acquiring an aircraft piloting model and a reward function including a piloting constraint, and application, to the piloting model, of a reinforcement learning algorithm to obtain state variables and piloting commands. The method also includes formation of data group(s) from the state variables and the commands. For the or each group, the method includes assignment of at least one aircraft state to the state variables and at least one piloting action to the commands, to generate a piloting rule including the state(s) and piloting action(s). The method also includes transmission of at least one piloting rule to a display device for display to a pilot of the aircraft.

### CROSS-REFERENCE TO RELATED APPLICATIONS

This application claims benefit under 35 USC § 371 of PCT Application No. PCT/EP2022/086202 entitled AIRCRAFT PILOTING ASSISTANCE METHOD, AND ASSOCIATED ELECTRONIC PILOTING ASSISTANCE DEVICE AND ASSISTANCE SYSTEM, filed on Dec. 15, 2022 by inventors Jaime Diaz-Pineda, Thomas De Lard and Baptiste Idiart. PCT Application No. PCT/EP2022/086202 claims priority of French Patent Application No. 21 13848, filed on Dec. 17, 2021.

### FIELD OF THE INVENTION

The present invention relates to a method for assisting the piloting of an aircraft.

The present invention also relates to an electronic device for assisting the piloting of the aircraft and a system for assisting the piloting of the aircraft comprising such an electronic device for assisting the piloting.

The invention relates to the field of aircraft piloting assistance.

### BACKGROUND OF THE INVENTION

For piloting a motor vehicle, it is known to use automatic pilots configured to determine piloting commands from state variables measured by vehicle sensors. The commands are then implemented in the vehicle to pilot it.

For this purpose, it is known to use a piloting model comprising a neural network, to which a reinforcement learning algorithm is applied. Such a reinforcement learning algorithm allows the model to learn by itself to determine the piloting commands from state variables and a reward function quantifying the effect of the determined commands on vehicle piloting.

However, in the aeronautical context, it is generally recommended, if not necessary, to obtain certification for the piloting system. Certification allows to guarantee that the piloting system will not determine inconsistent piloting commands that could jeopardize the integrity of the aircraft and its potential passengers. However, piloting systems comprising a model of the aforementioned type are not certifiable as they stand.

### SUMMARY OF THE DESCRIPTION

The aim of the invention is therefore to propose a method for assisting the piloting of an aircraft, an associated electronic piloting aid and a piloting assistance system, capable of providing certifiable piloting rules.

To this end, the invention has as its object a method for assisting the piloting of an aircraft, the method being implemented by an electronic piloting assistance device and comprising the following steps:
acquisition of a piloting model of the aircraft and a reward function including a piloting constraint,
application, to the piloting model, of a reinforcement learning algorithm from the reward function, the application step including the following sub-steps:
   reception of aircraft state variable(s) at reception times,
   for each reception time, modification of the model from an evaluation of the reward function from the state variable(s) received at said reception time, and
   for each reception time, a determination of piloting commands from the modified piloting model and the state variables received at said time,
formation of data group(s) from the state variables received and the commands determined, each data group comprising the state variables and the commands corresponding to a plurality of successive reception times,
for the or each data group, assignment of at least one aircraft state to the state variables and of at least one piloting action to the commands, to generate a piloting rule including the at least one state and the at least one piloting action,
transmission of at least one flight rule to a display device for the purpose of its display to a pilot of an aircraft.

Each piloting rule generated by the method can be certified, since it complies with a formalism allowing certification, that is, associating to at least one aircraft state, a piloting action to be implemented.

According to other advantageous aspects of the invention, the piloting assistance method comprises one or more of the following features, taken individually or in any technically possible combination:
during the application step, for each reception time, a value of the piloting constraint is calculated during the evaluation of the reward function, during the group(s) formation step, each data group further comprises the values of the piloting constraint associated with the state variables and the commands, during the assignment step, for the or each group, at least one constraint effect is assigned to the piloting constraint values of the group, each rule further comprising the at least one constraint effect;
during the assignment step, a plurality of rules is formed, the method further comprising, between the assignment step and the supply step, a step of identifying principal rule(s) from among the plurality of piloting rules generated by application of a variable frequency analysis algorithm, during the transmission step, only the principal rule(s) being transmitted;
the identification step further comprises comparing the effect(s) on the constraint of each principal rule with a predetermined threshold to obtain at least one filtered rule, each filtered rule being a respective principal rule comprising at least one effect on the constraint greater than or equal to the threshold, during the transmission step, only the filtered rule or rules being preferably supplied for the purpose of its display to the pilot of the aircraft;
the assignment step comprises, for each data group:
   a calculation of a first difference between the value of the piloting constraint at the last reception time from among the reception times of the state variables of the data group, and the value of the piloting constraint at the first reception time from among the reception times of the state variables of the data group,
   a calculation of a second difference between the value of the piloting constraint at a reception time later than the last reception time from among the reception times of the state variables of the data group, and the value of the piloting constraint at the first reception time from among the reception times of the state variables of the data group,
   assigning, to the piloting constraint values, a short-term effect on the piloting constraint from the first difference and a piloting constraint mapping table, and
   an assignment, to the piloting constraint values, of a long-term effect on the piloting constraint, from the second difference and the piloting constraint mapping table;
the formation step comprises:
   classification of the piloting commands determined from among a plurality of predefined classes and via a command mapping table,
   for each class, grouping the piloting commands belonging to said class and determined for the reception times forming the longest possible sequence of consecutive reception times, to form at least one set of grouped commands, and
for each set of grouped commands, formation of a respective group comprising the commands of said set and the state variables received at the reception times for which said commands have been determined;
during the acquisition step, a preliminary reward function is acquired, the method further comprising, between the acquisition step and the application step, a model training step by applying a preliminary reinforcement learning algorithm to the piloting model from the preliminary reward function, the training step including a modification of the model from an evaluation of the preliminary reward function;
   the state variables are selected from among the group consisting of: a roll angle of the aircraft, a pitch angle of the aircraft, a yaw angle of the aircraft, a speed of the aircraft, an acceleration of the aircraft, a wind speed on contact with the aircraft, an orientation of the wind relative to the aircraft, and a position of the aircraft.

The invention also has as its object a computer program product comprising software instructions which, when implemented by a computer, implement a method according to any of the preceding claims.

The invention also has as its object an electronic device for assisting the piloting of an aircraft, comprising:
an acquisition module configured to acquire an aircraft piloting model and a reward function comprising a piloting constraint,
an application module configured to apply to the piloting model a reinforcement learning algorithm from the reward function, the application module including:
   a reception unit configured to receive at least one aircraft state variable at reception times,
   a modification unit configured to modify, for each reception time, the model from an evaluation of the reward function from the state variable(s), and
   a determination unit configured to determine, for each reception time, piloting commands from the modified piloting model and the state variables received at said reception time,
a formation module configured to form at least one data group from the received state variables and the determined commands, each data group comprising the state variables and the determined commands corresponding to a plurality of successive reception times,
an assignment module configured to assign, for the or each data group, at least one aircraft state to the received state variables and at least one piloting action to the determined commands, and to generate a piloting rule including the at least one state and the at least one piloting action, and
a transmission module configured to transmit, to a display device, at least one piloting rule for the purpose of its display to the pilot of the aircraft.

Furthermore, the invention has as its object, an aircraft piloting assistance system of an aircraft comprising such an electronic piloting assistance device and a display device configured to receive at least one piloting rule from the piloting assistance device and to display said rule to the pilot of the aircraft.

### BRIEF DESCRIPTION OF THE DRAWINGS

These features and advantages of the invention will become clearer on reading the following description, given solely by way of non-limiting example and made with reference to the appended drawings, on which:

FIG. 1 is a schematic view of an aircraft piloting assistance system according to the invention, comprising an electronic piloting assistance device according to the invention;

FIG. 2 is a representation of a classification of piloting commands determined by the electronic piloting assistance device of FIG. 1;

FIG. 3 is a view of an aircraft trajectory calculated by the piloting assistance system of FIG. 1; and

FIG. 4 is a flowchart of a piloting assistance method according to the invention, implemented by the piloting assistance device of the piloting assistance system of FIG. 1.

### DETAILED DESCRIPTION OF EMBODIMENTS

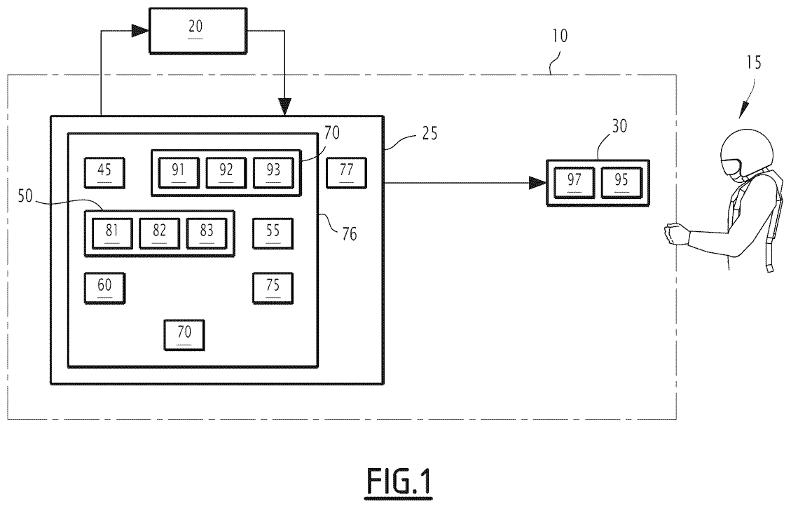

With reference to FIG. 1, an aircraft piloting assistance system 10 is described. The assistance system 10 is configured to provide, to a pilot 15 of the aircraft, the piloting rules. The assistance system 10 is connected to a device 20 for generating state variables VEᵢ of the aircraft, which will be described below.

In the remainder of this description, “aircraft” is taken to mean a flying machine able to be piloted by the pilot 15, such as an airplane, helicopter or drone. In particular, the pilot of the aircraft is either on board the aircraft, notably in the case of an airplane or helicopter, or remote from said aircraft, notably in the case of a drone.

The assistance system 10 comprises an electronic piloting assistance device 25 and a display device 30.

The generation device 20 for generating state variables is, for example, an aircraft simulation environment. The generation device 20 is configured to simulate the behavior of the aircraft along a trajectory including waypoints. More specifically, the generation device is configured to simulate the behavior of the aircraft between an initial position and a final position. The final position preferably corresponds to the last waypoint on the trajectory. If the aircraft has reached the final position, or if a predefined maximum time has elapsed, the generation device 20 restarts the simulation by repositioning the aircraft to the initial position.

The generation device 20 is then configured to receive, from the electronic piloting assistance device 25, the piloting commands Cᵢ of the aircraft. The generation device 20 is then configured to simulate, for a predefined duration, the behavior of the aircraft following the implementation of the received piloting commands Cᵢ. The generation device 20 is configured to supply the piloting assistance device 25 the state variables VEᵢ of the aircraft following simulation of the aircraft behavior for the predefined duration. The predefined duration is, for example, equal to 200 ms.

The piloting commands Cᵢ are the instructions, or the commands, intended to be received by the aircraft actuators and allowing the piloting of the aircraft.

In the embodiment in which the aircraft is an airplane, the piloting commands Ci are, for example, selected from among the group consisting of:
a position of the aircraft yaw control surface,
a position of the aircraft pitch control surface,
a position of the aircraft flaps,
a position of the aircraft ailerons, and
an aircraft engine fuel flow.

In the embodiment in which the aircraft is a drone, the piloting commands Cᵢ are, for example, the rotational speeds of each drone rotor.

The state variables VEᵢ of the aircraft are the variables used to define the state of the aircraft in its environment. The state variables VEᵢ are, for example, selected from among the group consisting of:
an aircraft roll angle,
an aircraft pitch angle,
an aircraft yaw angle,
an aircraft acceleration,
an aircraft speed,
a position of the aircraft, such as a relative position of the aircraft relative to the next waypoint or the next two waypoints, and optionally
a wind speed on contact with the aircraft, and
a wind direction relative to the aircraft.

While it is understood that the implementation of the piloting commands Cᵢ, by the generation device 20, and the simulation of the aircraft behavior during the predefined duration lead to a variation in the state variables VEᵢ.

According to one alternative, the generation device 20 is included in the aircraft and comprises a set of aircraft sensors and actuators. Thus, the generation device 20 comprises the actuators able to implement the received piloting commands Cᵢ and the sensors able to measure the state variables VEᵢ of the aircraft after the predefined duration.

The electronic piloting assistance device 25 is connected to the generation device and to the display device 30. The assistance device 25 is configured to generate, from the generation device 20, the piloting rules and to provide them to the display device 30, as will be detailed below.

The assistance device 25 comprises an acquisition module 45, an application module 50, a formation module 55, an assignment module 60, a transmission module 65 and optionally a training module 70 and an identification module 75.

In the example of the embodiment shown in FIG. 1, the acquisition module 45, the application module 50, the formation module 55, the assignment module 60, the supply module 65, and optionally the training module 70 and the identification module 75, are each realized in the form of software, or a software brick, executable by a processor 77. A memory 76 of the assistance device 25 is then able to store an acquisition software, an application software, a formation software, a supply software, and optionally a training software and an identification software.

In an alternative, not shown, the acquisition module 45, the application module 50, the formation module 55, the assignment module 60, the supply module 65, and optionally the training module 70 and the identification module 75, are each realized in the form of a programmable logic component, such as a Field Programmable Gate Array (FPGA)′ or an integrated circuit, such as an Application Specific Integrated Circuit (ASIC).

When the assistance device 25 is realized as one or more software program(s), in other words, as a computer program, it is also able to be recorded on a computer-readable medium (not shown). The computer-readable medium is, for example, a medium capable of storing electronic instructions and to be connected to a bus of a computer system. By way of example, the readable medium is an optical disk, a magneto-optical disk, a ROM memory, a RAM memory, any type of non-volatile memory (for example, EPROM, EEPROM, FLASH, NVRAM), a magnetic card or an optical card. A computer program comprising the software instructions is then stored on the readable medium.

The acquisition module 45 is configured to acquire an aircraft piloting model, a reward function FR comprising a piloting constraint, and optionally a command mapping table, a state mapping table, and a preliminary reward function FRP not comprising the piloting constraint and an effect mapping table on the piloting constraint.

The piloting model is able to receive as input the state variables VEᵢ of the aircraft and to provide as output the piloting commands Cᵢ of the aircraft. The piloting model is, for example, an artificial neural network comprising an input layer including a number of neurons equal to the number of state variables VEᵢ. The model also comprises one or more hidden layers, each including respectively a plurality of neurons, and an output layer including a number of neurons equal to the number of piloting commands Cᵢ. The model also comprises connections between the neurons of the various successive layers, each connection having an adjustable weight, also known as a synaptic weight.

The reward function is a function taking state variables VEᵢ as input, and providing a numerical value as output. The reward function comprises the piloting constraint representative of a piloting intention imposing compliance with the constraint(s).

According to a first example, the piloting intention is an environmentally responsible flight. In this example, the piloting constraint is an environmental constraint.

According to a second example, the piloting intention is a shortest flight, the associated constraint then being a flight time constraint.

The reward function FR is incremented, at each of a plurality of iterations, by the following magnitude:

$$RT + ROA + C P \qquad [ Math 1 ]$$

where RT is a trajectory reward, for example equal to 0 if the position of the aircraft is not on a waypoint, 10 if the position of the aircraft is on a waypoint, and −2 if the aircraft has missed the waypoint, in other words, if the position of the aircraft is in a waypoint environment without being on the waypoint, and
ROA is the acceleration orientation reward, for example equal to 1−ABS ((accelerationX+1)⁻³), where ABS ( ) designates the absolute value function and accelerationX designates the norm of the acceleration of the aircraft taking gravity into account, and
CP is the piloting constraint.

For example, the magnitude accelerationX designates the acceleration norm according to the axis connecting the tips of the two wings of the aircraft. ROA is therefore a constraint that allows to avoid passengers being thrown against the side of the aircraft during a turn. ROA therefore allows the aircraft to behave more or less realistically.

According to the first example, the piloting constraint is, for example, equal to:

$$CP = projection \cdot {10}^{- 14} \qquad [ Math 2 ]$$

where projection is the scalar product of aircraft speed and wind speed.

This piloting constraint thus allows the value of the reward function to be increased when the aircraft is carried by the wind and its fuel consumption is reduced.

According to the second example, the piloting constraint is, for example, equal to:

$$C P = γ \qquad [ Math 3 ]$$

where γ is a positive constant.

According to the second example, at each iteration, the reward function FR is incremented by the value γ. Thus, the route that minimizes the reward function is the one that minimizes the number of iterations, that is, the one that leads to the shortest flight.

The command mapping table comprises intervals of values for the piloting commands Cᵢ, and associates a piloting action with each interval.

Similarly, the state mapping table comprises intervals of values for the state variables VEᵢ, and associates an aircraft state with each of said intervals.

Similarly, the piloting constraint effect mapping table comprises value intervals for the piloting constraint values CPᵢ and associates with each of said intervals a short-term piloting constraint effect and a long-term piloting constraint effect.

The preliminary reward function FRP is a function which takes as input the state variables VEᵢ and provides as output a numerical value. As an example, the preliminary reward function FRP increments at each iteration by the following magnitude:

$$R T + R O A + R A \qquad [ Math 4 ]$$

where RT is the trajectory reward defined above,
ROA is the acceleration orientation reward defined above, and
RA is an alignment reward, for example equal to 1+(alignement+2)⁻³, where alignment is the scalar product of aircraft speed and direction between the aircraft and the next waypoint.

The application module 50 is configured to apply a reinforcement learning algorithm, from the reward function, to the piloting model. In particular, the application module 50 is configured to receive the state variables VEᵢ of the aircraft and determine the piloting commands Cᵢ at a plurality of successive reception times Tᵢ.

To this end, the application module 50 comprises a first reception unit 81, a first modification unit 82, and a first determination unit 83.

The first reception unit 81 is configured to receive, from the generation device 20, the state variables VEᵢ of the aircraft at successive reception times Tᵢ.

The first modification unit 82 is configured to modify, for each reception time Tᵢ, the model from an evaluation of the reward function from the state variables VEᵢ. To evaluate the reward function, the first modification unit 82 is configured to calculate the piloting constraint value from the state variables VEᵢ, for example according to one of the equations (2) or (3).

The first modification unit 82 is further configured to modify the weights of the model connections from the evaluation of the reward function. Such a modification is known to the person skilled in the art as a classic technique for applying the reinforcement learning algorithm.

The first determination unit 83 is configured to determine, for each reception time Tᵢ, the piloting commands Cᵢ from the modified piloting model and the state variables VEi received at said reception time Tᵢ. To do this, the first determination unit 83 is configured to apply the modified model, to the received state variables VEᵢ and to each reception time Tᵢ, and to determine the piloting commands Cᵢ of said reception time Tᵢ as being equal to the output values of the modified model.

Optionally, the application module 50 is configured to perform a predetermined number of iterations, each iteration comprising the reception of the state variables VEi of the aircraft by the first reception unit 81, the modification of the model by the first modification unit 82, and the determination of the piloting commands Cᵢ by the first determination unit 83.

Advantageously, the application module 50 is configured not to apply the reinforcement learning of the piloting model for a predefined number of iterations. Thus, at the end of the predefined number of iterations, the convergence weights have generally not reached convergence. The application module 50 is preferably configured to perform an exploration of possible aircraft trajectories, taking into account modifications to the model from the reward function, and in particular the piloting constraint comprised in the reward function.

The application module 50 is further configured to store, in a database and for each reception time Tᵢ, the received state variables VEᵢ, the determined piloting commands Cᵢ and preferably the piloting constraint CPᵢ values, calculated during evaluation of the reward function.

The formation module 55 is configured to form at least one data group from the received state variables VEᵢ, the determined commands Cᵢ and optionally the calculated piloting constraint values CPᵢ. Each data group comprises the state variables VEᵢ, the piloting commands Cᵢ, and optionally the piloting constraint values CPᵢ corresponding to successive reception times Tᵢ.

For example, the formation module 55 is configured to form a plurality of data groups. By way of example, the application module is configured to apply to the piloting commands Cᵢ, determined by the application module 50, a classification algorithm in order to classify, in the predefined classes CLᵢ, said determined piloting commands Cᵢ for each reception time Ti. The predefined classes CLᵢ are, for example, included in the command mapping table.

To this end, the formation module 55 is configured, for example, to compare, for each reception time Tᵢ, the piloting commands Cᵢ with the value intervals of the command mapping table, in order to determine to which class CL the piloting commands Cᵢ of said time Tᵢ correspond.

The formation module 55 is configured, for example, to group together the piloting commands Cᵢ belonging to the same respective class CLᵢ and the reception times Tᵢ of which form the longest possible sequence of consecutive reception times Tᵢ.

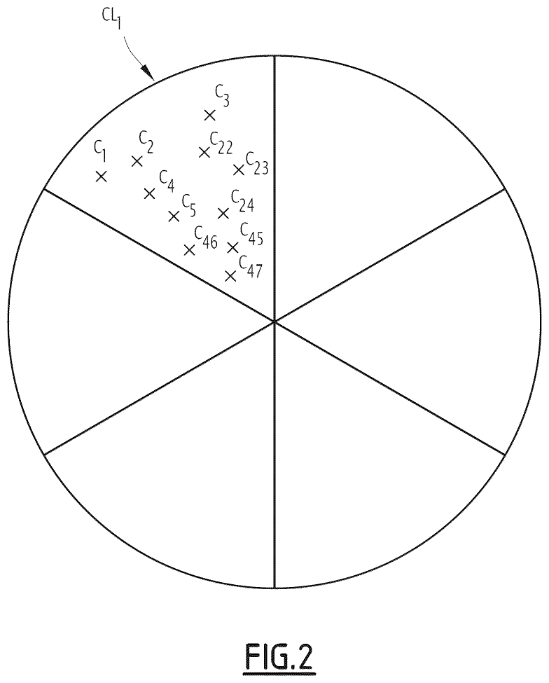

Referring to FIG. 2, several piloting commands C₁, C₂, C₃, C₄, C₅, C₂₂, C₂₃, C₂₄, C₄₅, C₄₆, C₄₇ belong to a first class CL₁. These commands C₁, C₂, C₃, C₄, C₅, C₂₂, C₂₃, C₂₄, C₄₅, C₄₆, C₄₇ correspond respectively to the following reception times Tᵢ: T₁, T₂; T₃, T₄, T₅; T₂₂; T₂₃, T₂₄, T₄₅, T₄₆, T₄₇. The formation module 55 is then configured to group together, firstly, the following pilot commands: C₁, C₂, C₃, C₄, C₅, secondly, the following piloting commands: C₂₂, C₂₃, C₂₄, and thirdly the following piloting commands: C₄₅, C₄₆, C₄₇.

The formation module 55 is further configured to form each data group as comprising a plurality of respective grouped commands Cᵢ, the corresponding state variables VEᵢ, and optionally, the corresponding piloting constraint values CPᵢ. By “corresponding state variables VEᵢ” is meant the state variables VEᵢ received at the reception times Tᵢ corresponding to the grouped commands Cᵢ. Similarly, by “corresponding piloting constraint values CPᵢ” is meant the piloting constraint values CPᵢ calculated for the reception times Tᵢ corresponding to the grouped commands Cᵢ.

Thus, in the previous example shown in FIG. 2, a first data group comprises the following commands: C₁, C₂, C₃, C₄, C₅, the corresponding state variables VEᵢ: VE₁, VE₂, VE₃, VE₄, VE₅, and optionally, the corresponding piloting constraint values: CP₁, CP₂, CP₃, CP₄, CP₅.

Similarly, a second data group comprises the following commands: C₂₂, C₂₃, C₂₄, the corresponding state variables VEᵢ: VE₂₂, VE₂₃, VE₂₄, and optionally, the corresponding piloting constraint values: CP₂₂, CP₂₃, CP₂₄.

A third group includes the following commands: C₄₅, C₄₆, C₄₇, the corresponding state variables VEᵢ: VE₄₅, VE₄₆, VE₄₇, and optionally, the corresponding piloting constraint values: CP₄₅, CP₄₆, CP₄₇.

The assignment module 60 is configured to assign, for the or each data group: at least one aircraft state to the state variables VEᵢ, at least one piloting action to the piloting commands Cᵢ, and optionally, at least one effect on the piloting constraint to the piloting constraint values CPᵢ.

The assignment module 60 is configured, for example, to assign to the commands Cᵢ of each group, the at least one action from the command mapping table. The command mapping table comprises for example, for each predefined class CLᵢ, at least one action. The assignment module 60 is preferably configured to assign to the commands Cᵢ of each group, the action(s) corresponding to the class CLᵢ of these commands Cᵢ in the command mapping table.

Each action is, for example, a textual label describing the piloting action performed by the respective piloting commands Cᵢ. By way of example, the actions are selected from among the group consisting of:
a turn toward the right of the aircraft,
a turn toward the left of the aircraft,
a straight trajectory of the aircraft,
a climb of the aircraft,
a descent of the aircraft,
an acceleration of the aircraft,
a deceleration of the aircraft, and
an aircraft maintaining speed.

Clearly, the assignment module 60 is configured, for example, to assign several actions to the commands Cᵢ of a data group.

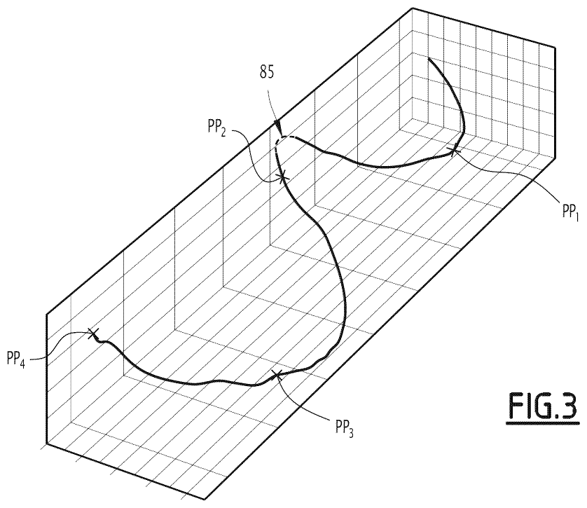

FIG. 3 shows the flight path of an aircraft according to a trajectory comprising a first PP₁, a second PP₂, a third PP₃ and a fourth PP₄ waypoints. In the example shown in FIG. 3, a dotted portion 85 of the flight path corresponds to a data group.

In the example shown in FIG. 3, the assignment module 60 is configured, for example, to assign to the commands Cᵢ of the group corresponding to the portion 85, the following actions: a turn toward the left of the aircraft, a descent of the aircraft, and a deceleration of the aircraft.

The assignment module 60 is configured, for example, to assign to the state variables VEᵢ, the at least one state from the state mapping table. Each state is, for example, a textual label describing the state of the aircraft as a function of the state variables VEᵢ of said aircraft. By way of example, the states are chosen from among the group consisting of:
the aircraft is very close to the next waypoint,
the aircraft is close to the next waypoint,
the aircraft is far from the next waypoint,
the aircraft is very far from the next waypoint,
the aircraft is far to the left of the next waypoint,
the aircraft is slightly to the left of the next waypoint,
the aircraft is slightly to the right of the next waypoint,
the aircraft is far to the right of the next waypoint,
the aircraft is high above the next waypoint,
the aircraft is slightly above the next waypoint,
the aircraft is slightly below the next waypoint,
the aircraft is far below the next waypoint,
the aircraft is very close to the waypoint following the next waypoint,
the aircraft is close to the waypoint following the next waypoint,
the aircraft is far from the waypoint following the next waypoint,
the aircraft is very far from the waypoint following the next waypoint,
the aircraft is far to the left of the waypoint following the next waypoint,
the aircraft is slightly to the left of the waypoint following the next waypoint,
the aircraft is slightly to the right of the waypoint, following the next waypoint,
the aircraft is far to the right of the waypoint, following the next waypoint,
the aircraft is high above the waypoint, following the next waypoint,
the aircraft is slightly above the waypoint, following the next waypoint,
the aircraft is slightly below the waypoint, following the next waypoint,
the aircraft is far below the waypoint, following the next waypoint,
the aircraft is very close to the previous waypoint,
the aircraft is close to the previous waypoint,
the aircraft is far from the previous waypoint,
the aircraft is very far from the previous waypoint,
the aircraft is far to the left of the previous waypoint,
the aircraft is slightly to the left of the previous waypoint,
the aircraft is slightly to the right of the previous waypoint,
the aircraft is far to the right of the previous waypoint,
the aircraft is high above the previous waypoint,
the aircraft is slightly above the previous waypoint,
the aircraft is slightly below the previous waypoint,
the aircraft is far below the previous waypoint,
the roll angle is strongly negative,
the roll angle is slightly negative,
the roll angle is slightly positive,
the roll angle is strongly positive,
the pitch angle is strongly negative,
the pitch angle is slightly negative,
the pitch angle is slightly positive,
the pitch angle is strongly positive,
the wind in contact with the aircraft is very strong,
the wind in contact with the aircraft is strong,
the wind in contact with the aircraft is weak,
the wind in contact with the aircraft is very weak,
the aircraft has a headwind,
the aircraft has a tailwind,
the aircraft has the wind from the right side, and
the aircraft has the wind from the left side.

For example, the assignment module 60 is further configured to calculate, for each group, a time average of the value of each state variable VEᵢ in the group. By “time average” we mean the average calculated between all the reception times Tᵢ of the state variables VEᵢ in the group.

The assignment module 60 is configured to then assign to the state variables VEᵢ of each group, the at least one state by comparing the average values of the state variables VEᵢ with the intervals corresponding to each state in the state mapping table.

Clearly, the assignment module 60 is configured, for example, to assign several states to the state variables VEᵢ of a data group.

In the example shown in FIG. 3, the assignment module 60 is configured, for example, to assign to the state variables VEᵢ of the group corresponding to the portion 85, the following states: the aircraft is close to the next waypoint, the aircraft is slightly above the next waypoint, the aircraft is slightly to the right of the next waypoint, the aircraft is far from the previous waypoint, the aircraft is high above the previous waypoint, the aircraft is far to the right of the previous waypoint, the sine of the roll angle is strongly negative, the wind in contact with the aircraft is weak, and the aircraft has a headwind.

The assignment module 60 is further configured to generate, for each group, a piloting rule including the at least one state and the at least one piloting action, assigned to the group.

In the example shown in FIG. 3, the piloting rule generated for the portion 85, for example, is:
when the aircraft is close to the next waypoint, the aircraft is slightly above the next waypoint, the aircraft is slightly to the right of the next waypoint, the aircraft is far from the previous waypoint, the aircraft is high above the previous waypoint, the aircraft is far to the right of the previous waypoint, the sine of the roll angle is strongly negative, the wind in contact with the aircraft is weak, and the aircraft has a headwind,
perform: a turn toward the left of the aircraft, a descent of the aircraft, and a deceleration of the aircraft.

As an optional addition, the assignment module 60 is further configured to calculate, for each group, a first difference between the value of the piloting constraint CP_{d} at the last reception time T_{d} from among the reception times Tᵢ of the state variables VEᵢ of the data group and the value of the piloting constraint CPₚ at the first reception time Tₚ from among the reception times Tᵢ of the state variables VEᵢ of the data group.

The first reception time Tₚ is the first, that is, the oldest, of the reception times Tᵢ of the state variables VEᵢ of the group. Similarly, the last reception time T_{d} is the last, that is the most recent, of the reception times Tᵢ of the state variables VEᵢ of the group.

The assignment module 60 is then configured to assign a short-term effect on the piloting constraint to the CPᵢ piloting constraint values, from the first difference and the piloting constraint mapping table. Each short-term effect is, for example, a textual label describing whether or not the action(s) implemented, when the aircraft is in the or the state(s), has a positive effect on the piloting constraint within a short time frame. By way of example, the short-term effects are chosen from among a group consisting of:
a very negative short-term effect on the piloting constraint,
a negative short-term effect on the piloting constraint,
a positive short-term effect on the piloting constraint, and
a very positive short-term effect on the piloting constraint.

According to this same optional addition, the assignment module 60 is further configured to calculate, for each group, a second difference between the value of the piloting constraint CP_{final} at a reception time T_{final} subsequent to the last reception time T_{d} from among the reception times Tᵢ of the state variables VEᵢ of the data group and the value of the piloting constraint CPₚ at the first reception time Tₚ from among the reception times Tᵢ of the state variables VEᵢ of the data group. The reception time T_{final} subsequent to said last reception time T_{d} is, for example, the last reception time Tᵢ of the trajectory simulation. In other words, the said time T_{final} is the last reception time Tᵢ before the aircraft is repositioned to the initial point by the generation module 20. In FIG. 3, this time Tᵢ is that at which the aircraft has reached the fourth waypoint PP₄, or final position of the trajectory.

The assignment module 60 is then configured to assign, to the piloting constraint values CPᵢ, a long-term effect on the piloting constraint, from the second difference and the piloting constraint mapping table. In a similar way to the short-term effects, each long-term effect is, for example, a textual label describing whether the action(s) implemented, when the aircraft is in the state(s), is positive or not on the piloting constraint, within a long time frame. By way of example, the long-term effects are chosen from among the group consisting of:
a very negative long-term effect on the piloting constraint,
a negative long-term effect on the piloting constraint,
a positive long-term effect on the piloting constraint, and
a very positive long-term effect on the piloting constraint.

According to this optional addition, the assignment module 60 is configured to generate, during generation of the piloting rule, the rule further comprising the short-term effect on the piloting constraint and the long-term effect on the piloting constraint. Thus, in the example shown in FIG. 3, the rule generated for the portion 85 is, for example:
when the aircraft is close to the next waypoint, the aircraft is slightly above the next waypoint, the aircraft is slightly to the right of the next waypoint, the aircraft is far from the previous waypoint, the aircraft is high above the previous waypoint, the aircraft is far to the right of the previous waypoint, the sine of the roll angle is strongly negative, the wind in contact with the aircraft is weak, and the aircraft has a headwind,
perform: a turn toward the left of the aircraft, a descent of the aircraft, and a deceleration of the aircraft,
has an effect on the piloting constraints: very positive in the short term, and negative in the long term.

The transmission module 65 is configured to transmit to the display device 30, the piloting rules for the purpose of its display to the pilot 15 of the aircraft.

The training module 70 is configured to train the piloting model to follow the trajectory by applying a preliminary reinforcement learning algorithm to the model, from the preliminary reward function. The training module 70 comprises a second reception unit 91, a second modification unit 92, and a second determination unit 93.

The second reception unit 91 is similar to the first reception unit 81. The state variables received by the second reception unit 91 are known as preliminary state variables in the present description. The second receiving unit 91 is then configured to receive the preliminary state variables at preliminary reception times.

The second modification unit 92 is substantially similar to the first modification unit 82 except that the second modification unit 92 is configured to modify the model from an evaluation of the preliminary reward function instead of the reward function.

The second determination unit 93 is similar to the first determination unit 83. The piloting commands determined by the second determination unit 93, configured to determine, are referred to as preliminary commands in this description. The second determination unit 93 is then configured to determine said preliminary commands.

Unlike the application module 50, the training module 70 is configured to receive the preliminary state variables, modify the model and determine the preliminary commands at several successive preliminary times until the preliminary reinforcement learning algorithm converges, in other words, until the model weights are no longer substantially modified by the second modification unit 92. The model is then said to be trained.

The training module 70 is further configured to transmit, to the application module 50, the trained model. The application module 50 is then configured to apply the reinforcement learning algorithm to the trained model rather than to the model acquired by the acquisition module 45.

The identification module 75 is optionally configured to, if the rules comprising the at least one effect on the constraint, identify at least one principal rule from among the plurality of generated rules. To this end, the identification module 75 is advantageously configured to apply a variable frequency analysis algorithm, known per se, from a predefined support threshold and a predefined confidence threshold.

The support quantifies the frequency of occurrence of a triplet, “state(s), action(s), effect(s) on the constraint” from among the set of rules. The support is between 0 and 1. For example, if the support threshold is equal to 0.5, then each triplet, “state(s), action(s), effect(s) on constraint” of the principal rule(s) appears in at least 50% of the piloting rules.

The confidence quantifies the frequency of appearance of a triplet, “state(s), action(s), effect(s) on constraint” from among the rules comprising the said state(s) and the said action(s). The confidence is between 0 and 1. For example, if the confidence threshold is equal to 0.9, then for each principal rule, “state(s), action(s), effect(s) on constraint”, the effect(s) on the constraint appear in at least 90% of the piloting rules comprising the said state(s) and the said action(s).

Thus, the identification module 75 is configured to identify, from among the piloting rules, the principal rule or rules the support and the confidence of which are greater than the respective thresholds.

Optionally, the identification module 75 is further configured to, if the rules comprise the at least one constraint effect, compare the constraint effects of each principal rule with a respective predetermined threshold, to obtain at least one filtered rule. The predetermined threshold is, for example, equal to: very positive effect, positive effect or negative effect. More specifically, the identification module 75 is optionally configured to select only those principal rules of which at least one of the effects on the piloting constraint is greater than or equal to the predetermined threshold. In the present description, “very positive” is taken to mean greater than or equal to: very positive, positive, negative and very negative”, “positive” is taken to mean greater than or equal to: positive, negative and very negative” and “negative” is taken to mean greater than or equal to: negative and very negative”.

If the assistance device 25 comprises the identification module 75, the transmission module 65 is configured to transmit, to the display device 30, only each principal rule or each filtered rule.

The display device 30 is, for example, on board the aircraft if the aircraft is an airplane, or remote from the aircraft if the aircraft is a drone.

The display device 30 comprises, for example, a display screen 95 and optionally a processing unit 97 connected to the display screen 95.

The display screen 95 is, for example, able to display content transmitted by the processing unit 97.

The processing unit 97 is configured to receive, from the assistance device 25, at least one piloting rule. The processing unit 97 is configured, for example, to implement a chatbot able to interact with the pilot 15. The processing unit 97 is configured to display, on the display screen 95, the piloting rule(s) received, for example following interaction with the pilot 15.

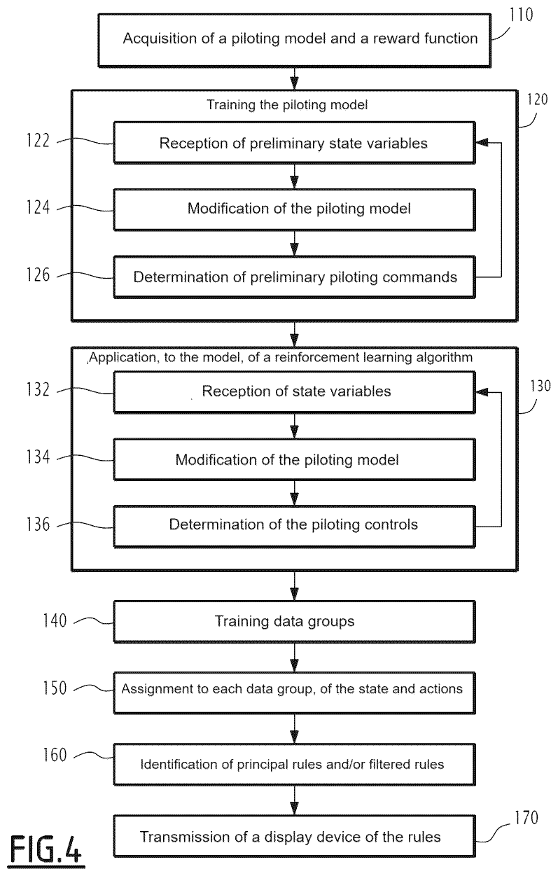

The operation of the assistance system 10, and more particularly of the assistance device 25, will now be described with reference to FIG. 4 showing a flow chart of a piloting assistance method according to the invention.

During an acquisition step 110, the acquisition module 45 acquires the aircraft piloting model, the reward function; as well as, optionally, the command mapping table, the state mapping table, the preliminary reward function and the effect mapping table for the piloting constraint.

Optionally, in a model training step 120, the training module 70 applies the preliminary reinforcement learning algorithm to the model, in order to train it to follow the trajectory.

To this end, during a first reception sub-step 122, the second reception unit 91 receives, from the generation device 20, and at the preliminary reception times, the preliminary state variables of the aircraft.

For each preliminary reception time, during a first modification sub-step 124, the second modification unit 92 evaluates the preliminary reward function from the preliminary state variables received, for example using the preceding equation (4). The second modification unit 92 then modifies the model weights as a function of the preliminary reward function value, according to a technique known per se.

For each preliminary reception time, during a first determination sub-step 126, the second determination unit 93 determines the preliminary commands, for example, by applying the modified model to the preliminary state variables received.

For each preliminary reception time, the training module 70 transmits, to the generation device 20, the determined preliminary commands. The training module 70 then waits to receive, from the generation device 20, the preliminary state variables of the aircraft at the next preliminary reception time. The training module 70 then repeats the first reception 122, the modification 124 and the determination 126 sub-steps.

During the training step 120, the reception 122, the modification 124 and the determination 126 sub-steps are repeated until model convergence is achieved.

At the end of the training step 120, the model is trained to track the trajectory.

Then, during an application step 130, the application module 50 applies the reinforcement learning algorithm to the trained model.

To do this, during a second reception sub-step 132, the first reception unit 81 receives, from the generation device 20 and at successive reception times Tᵢ, the state variables VEᵢ of the aircraft.

Then, for each reception time Tᵢ, during a second modification sub-step 134, the first modification unit 82 evaluates the reward function from the received state variables VEᵢ, for example according to the equation (1). To this end, the first modification unit 82 calculates the value of the piloting constraint CPᵢ, for example according to one of the equations (2) or (3). Then, similarly to the first modification sub-step 124, the first modification unit 82 modifies the weights of the trained model according to a technique known per se.

For each reception time Tᵢ, during a second determination sub-step 136, the first determination unit 83 determines the piloting commands Cᵢ by applying the modified model to the state variables VEᵢ, for example in a manner similar to that performed during the first determination sub-step 126.

During the application step 130, for each reception time T₁, the application module 50 transmits, to the generation device 20, the determined piloting commands Cᵢ. The application module 50 then waits to receive, from the generation device 20, the state variables VEᵢ of the aircraft at the next reception time Tᵢ. The application module 50 then repeats the second reception 132, the modification 134 and the determination 136 sub-steps.

For each reception time T₁, the state variables VEᵢ received, the piloting commands Cᵢ determined, and advantageously the value of the piloting constraint CPᵢ calculated, are stored in the database.

During the application step 130, the second reception 132, the modification 134 and the determination 136 sub-steps, are repeated until the predefined number of iterations is reached.

Alternatively, if the method does not comprise the optional training step 120, the application module 50 applies, during the application step 130, the reinforcement learning algorithm to the model acquired in the acquisition step 110.

During a formation step 140, the formation module 55 forms at least one group comprising, for consecutive reception times Tᵢ, the received state variables VEᵢ, the determined piloting commands Cᵢ; and optionally the calculated values of the piloting constraint CPᵢ.

To this end, the formation module 55 compares, for example, the piloting commands Cᵢ, determined for each reception time Tᵢ, with the value intervals of the command mapping table, in order to determine to which class CLᵢ correspond the piloting commands Cᵢ determined at said time Tᵢ.

Then, the formation module 55 groups the piloting commands Cᵢ belonging to the same respective class CLᵢ and determined for the reception times Tᵢ forming the longest possible sequence of consecutive reception times Tᵢ.

Then, the formation module 55 forms each group by including the grouped piloting commands Cᵢ, the corresponding state variables VEᵢ; and optionally the corresponding piloting constraint values CPᵢ.

During an assignment step 150, the assignment module 60 assigns, for each group, at least one action to the piloting commands Cᵢ of the group, for example by comparing the piloting commands C; with the ranges of values in the action mapping table.

The assignment module 60 also assigns, for each group, at least one state to the state variables VEᵢ of the group. To do this, the assignment module calculates, for example, the time average of the value of each state variable VEᵢ of the group, and compares each time average with the value ranges in the state mapping table.

If each group also comprises the values of the piloting constraint CPᵢ, the assignment module 60 calculates the first and second differences for each group as described above. The assignment module 60 then assigns, to the values of the piloting constraint CPᵢ the short-term effect on the constraint and the long-term effect on the constraint, comparing the first and second differences with the ranges of values in the constraint effect mapping table.

The assignment module 60 then generates, for each group, a rule, including the state(s) of the group, the action(s) of the group, and optionally the short-term effect on the constraint and the long-term effect on the constraint of the group.

As an optional addition, if the rules comprise at least one respective effect on the piloting constraint, the identification module 75 identifies, during an identification step 160, the at least one principal rule from among the generated rules. For example, the identification module 75 applies, to the generated rules, the variable frequency analysis algorithm defined above.

During the identification step 160, the identification module 75 optionally compares the effects on the piloting constraint included in each principal rule with the predetermined threshold, to obtain at least one filtered rule. Thus, only the principal rules having a very positive, at least positive or at least negative effect on the constraint are, for example, included in the filtered rules.

During a transmission step 170, the transmission module 65 transmits, to the display device 30, the generated rules or, if need be, the at least one principal rule or the at least one filtered rule.

The display device 30 then displays, for the purpose of its display to the pilot 15, the rules transmitted by the transmission module 65.

For example, while the aircraft is in flight, the pilot 15 interacts with the chatbot implemented by the processing unit 97, to find out the effect(s) on the piloting constraint of implementing one or more respective piloting actions in the state(s) in which the aircraft is. The processing unit 97 then controls the display on the display screen 95 of all or part of the piloting rule comprising said action(s) and/or said state(s).

With the assistance method according to the invention, the piloting rules generated can then be certified.

In addition, thanks to the reinforcement learning algorithm, the method is able to generate a large number of piloting rules without the need for human intervention. Thus, the risk of the pilot 15 being confronted with an aircraft state that is absent from the piloting commands Cᵢ is limited.

Furthermore, the determination of piloting commands Cᵢ according to the reinforcement learning algorithm allows to determine the piloting commands that would not have been taken into account by a human operator, leading to the generation of additional rules that a human operator would not have considered.

The formation step 140 allows the formation of sufficiently small, that is, reduced, groups of data, so that each group can correspond to one or more actions performed simultaneously. In addition, the formation step 140 allows the formation of sufficiently large, that is, important, data groups, so that the action(s) assigned to the commands Cᵢ of said group have a quantifiable effect on the piloting constraint.

In addition, the optional training step 120 allows to provide the input for the application step 130, the piloting model trained to track the trajectory. However, tracking the trajectory is the primary mission of the aircraft. Thus, during the application step 130, the model will continue to substantially follow the trajectory, while introducing slight variations in direction having a substantially positive effect on the piloting constraint.

The optional identification step 160 allows to extract, from the generated rules, only the most representative actions and states, in other words, those which have been encountered most often, that is, the most frequent, and in which the pilot 15 can have confidence. In addition, this step 160 allows to limit the number of rules to be transmitted to the display device 30, while retaining the main elements of the generated rules.

1. A method for assisting the piloting of an aircraft, the method being implemented by an electronic piloting assistance device and comprising:
acquiring a piloting model of the aircraft and a reward function including a piloting constraint;
applying, to the piloting model, a reinforcement learning algorithm from the reward function, comprising:
receiving state variable(s) of the aircraft at the reception times;
for each reception time, modifying the model from an evaluation of the reward function from the state variable(s) received at the reception time; and
for each reception time, determining piloting commands from the modified piloting model and the state variables received at that time;
forming data group(s) from the received state variables and the determined commands, each data group comprising the state variables and the commands corresponding to a plurality of successive reception times;
for the or each data group, assigning at least one aircraft state to the state variables and at least one piloting action to the commands, to generate a piloting rule comprising the at least one state and the at least one piloting action, action; and
transmitting the at least one piloting rule to a display device for display to a pilot of the aircraft.

2. The method according to claim 1, wherein,
during said applying, for each reception time,
a value of the piloting constraint is calculated during evaluation of the reward function,
during said forming, each data group further comprises the values of the piloting constraint associated with the state variables and the commands, and
during said assigning, for the or each group, at least one effect on the constraint is assigned to the values of the piloting constraint of the group, each rule further comprising the at least one effect on the constraint.

3. The method according to claim 2, wherein
during said assigning a plurality of rules is formed, the method further comprising between said assigning and said applying, identifying the principal rule(s) from among the plurality of piloting rules generated by application of a variable frequency analysis algorithm, and
during said transmitting, only the principal rule(s) are transmitted.

4. The method according to claim 2, wherein said identifying further comprises comparing the effect(s) on the constraint of each principal rule with a predetermined threshold to obtain at least one filtered rule, each filtered rule being a respective principal rule comprising at least one effect on the constraint greater than or equal to the threshold.

5. The method according to claim 2, wherein said assigning comprises for each data group:
calculating a first difference between the value of the piloting constraint at the last reception time from among the reception times of the state variables of the data group, and the value of the piloting constraint at the first reception time from among the reception times of the state variables of the data group;
calculating a second difference between the value of the piloting constraint at a reception time subsequent to the last reception time from among the reception times of the state variables of the data group, and the value of the piloting constraint at the first reception time from among the reception times of the state variables of the data group;
assigning, to the piloting constraint, a short-term effect on the piloting constraint, from the first difference and a piloting constraint mapping table; and
assigning, to the piloting constraint values, a long-term effect on the piloting constraint from the second difference and the piloting constraint mapping table.

6. The method according to claim 1, wherein said forming comprises:
classifying the determined piloting commands from among a plurality of predefined classes and via a command mapping table;
for each class, grouping together the piloting commands belonging to the class and determined for the reception times forming the longest possible sequence of consecutive reception times, to form at least one set of grouped commands; and
for each set of grouped commands, forming a respective group comprising the commands of the set and the state variables received at the reception times for which the commands have been determined.

7. The method according to claim 1, wherein during said acquiring, a preliminary reward function is acquired, the method further comprising, between said acquiring and said applying, training a model, comprising:
applying a preliminary reinforcement learning algorithm to the piloting model from the preliminary reward function; and
modifying the model from an evaluation of the preliminary reward function.

8. The method according to claim 1, wherein the state variables are selected from among the group consisting of: an aircraft roll angle, an aircraft pitch angle, an aircraft yaw angle, an aircraft speed, an aircraft acceleration, a wind speed on contact with the aircraft, a wind orientation relative to the aircraft, and an aircraft position.

9. A computer program product comprising software instructions which, when implemented by a computer, implement a method according to claim 1.

10. An electronic device for assisting the piloting of an aircraft, comprising:
an acquisition module acquiring a piloting model of the aircraft and a reward function comprising a piloting constraint;
an application module applying to the piloting model a reinforcement learning algorithm from the reward function, comprising:
a reception unit configured to receive at least one state variable of an aircraft at the reception times;
a modification unit modifying, for each reception time, the model from an evaluation of the reward function from the state variable(s); and
a determination unit determining, for each reception time, the piloting commands from the modified piloting model and the state variables received at the reception time;
a formation module forming at least one data group from the received state variables and the determined commands, each data group comprising the state variables and the determined commands corresponding to a plurality of successive reception times;
an assignment module assigning, for the or each data group, at least one aircraft state to the received state variables and at least one piloting action to the determined commands, and generating a piloting rule including the at least one state and the at least one piloting action; and
a transmission module transmitting, at least one piloting rule to a display device for display to a pilot of the aircraft.

11. An aircraft flight assistance system comprising:
an electronic piloting assistance device according to claim 10; and
a display device configured to receive at least one piloting rule from said piloting assistance device and to display the rule to the pilot of the aircraft.

12. The method according to claim 4 wherein during said transmitting, only the filtered rule or rules are supplied for display to the pilot of the aircraft.
